(19) United States
(12) Patent Application Publication
(10) Pub. No.: US 2007/0227891 A1
(43) Pub. Date: Oct. 4, 2007

(54) Differential alternating field electrophoresis method and an electrophoresis system therefor

(75) Inventors: Heng Hang Tsai, Singapore (SG); Hon Chiu Eastwood Leung, Singapore (SG)

Correspondence Address: CONLEY ROSE, P.C.;David A. Rose, P. O. BOX 3267, HOUSTON, TX, 77253-3267, US

(73) Assignee: Agency for Science, Technology and Research, Singapore (SG)

(21) Appl. No.: 10/959,454

(22) Filed: Oct. 6, 2004

(51) Int. Cl. G01N 27/447

(52) U.S. Cl. 204/457; 204/608

(57) ABSTRACT

Notable techniques for protein separation prior to any further downstream analysis include the Sodium Doecyl Sulphate-PolyAcrylamide Gel Electrophoresis (SDS-PAGE). However, SDS-PAGE suffers from limitations such as band broadening and the ineffective separation of proteins or proteins isoforms with very similar migration mobilities under the influence of an electric field. Currently, the best method for protein separation and resolution with very narrow molecular weight variation utililizing SDS-PAGE is by pulse electrophoresis. However, pulse electrophoresis introduces new limitations such as the long run period required, band broadening contributed by diffusion when the electrical field is switched off, and the need for casting of inconvenient and unconventional long separating gel arise. An embodiment of the invention describes use of a differential alternating field electrophoresis (DAFE) method where electrical fields in substantially opposing directions are applied to proteins for separation thereof. By varying the duration of the electrical fields, forward directional and inverse directional pulsing of the electrical fields creates an advancing-dislodging effect on the proteins. The advancing-dislodging effect of the DAFE method facilitates migration of the proteins through the separation gel and thereby results in improved separation of the proteins using conventional electrophoresis devices.

### FIELD OF INVENTION

The present invention relates generally to a system for electrophoresis. In particular, the invention relates to an electrophoresis system for protein separation using differential alternating electrical fields.

### BACKGROUND

In a typical biological investigation laboratory, a notable technique used for protein separation prior to any further downstream analysis is the effective and convenient Sodium Doecyl Sulphate-PolyAcrylamide Gel Electrophoresis (SDS-PAGE). However, SDS-PAGE suffers from limitations such as band broadening and the ineffective separation of proteins or protein isoforms with very similar migration mobilities under the influence of an electric field.

Currently, the best method utilizing SDS-PAGE for the separation of proteins with proximate differences in molecular weights involves pulse field gel electrophoresis. Pulse field gel electrophoresis has been demonstrated and is described in a disclosed article. In the disclosed article, separation of different muscle myosin heavy chains was done by altering migration of protein bands by cyclically switching on and off the electric field. Although this new approach is an improvement over the resolution of existing SDS-PAGE, there are also attendant limitations such as the long run period required, band broadening contributed by diffusion when the electrical field is switched off, and the need for casting of inconvenient and unconventional long (32 cm) separating gel.

Hence, this clearly affirms a need for an improved electrophoresis system.

### SUMMARY

A new approach using SDS-PAGE or native PAGE for the separation of proteins/peptides or isoform differentiated with improved sharpness of protein bands and resolution, or separation distance between bands of interest within the confined area of a mini gel (6 cm) is demonstrated. The approach, hereinafter known as Differential Alternating Field Electrophoresis (DAFE), effectively and conveniently converts a normal existing power supply system into a system capable of delivering short pulses (milliseconds) of electric field in forward and reverse orders attached to a standard SDS-PAGE running apparatus, for example, mini gel cell (preferably from Invitrogen Corporation). By controlling the regime or ratio of forward and reverse pulsing periods and the gel concentration, DAFE has the ability to focus or ‘zoom in’ on different desired molecular weight range within the confinement of a mini separation gel in a relatively short period of time. Therefore, this method can better resolve not only for high molecular weight proteins, but also for low molecular weight (as low as 28 kDa) protein isoforms by altering the pulse set up of the electrical fields in conjunction with the appropriate polyacrylamide gel concentration.

Therefore, in accordance with a first aspect of the invention, there is disclosed an electrophoresis system for separating macromolecules comprising:

a switching assembly;

an electrophoresis device being electrically couplable to the switching assembly, the electrophoresis device comprising:
a migration medium having an origin location and an objective location forming extremities thereof, and
an electrode assembly for applying electrical potential through the migration medium, the switching assembly being in electrical communication with the electrode assembly; and

a controller being in electrical communication with the switching assembly, the controller cooperating with the switching assembly to control application of a first electrical field and a second electrical field in an alternating pulse sequence by the electrode assembly to at least a portion of macromolecules introducible at the origin location and containable in the migration medium,

wherein the first electrical field is for spatially displacing at least a portion of the macromolecules along a first resultant direction and the second electrical field is for moving at least a portion of the macromolecules along a second resultant direction, the first resultant direction substantially opposing the second resultant direction,

whereby when macromolecules are introduced at the origin location, applying the first electrical field for a first pulse duration and applying the second electrical field for a second pulse duration in the alternating pulse sequence thereto electrophoretically migrates the maromolecules towards the objective location for separation thereof, the first pulse duration and the second pulse duration being pre-determined, each macromolecule having a plurality of molecular properties and the macromolecules being separated by the migration medium in accordance with at least one of the plurality of molecular properties.

In accordance with a second aspect of the invention, there is disclosed a differential alternating field electrophoresis (DAFE) method for separating macromolecules comprising the steps of:

providing an electrophoresis device comprising:
a migration medium having an origin location and an objective location forming extremities thereof; and
an electrode assembly for applying electrical potential through the migration medium,

providing a switching assembly being electrically couplable to the electrophoresis device, the switching assembly being in electrical communication with the electrode assembly;

electrically communicating a controller with the switching assembly;

applying a first electrical field and a second electrical field in an alternating pulse sequence by the electrode assembly to at least a portion of macromolecules introducible at the origin location and containable in the migration medium, the controller cooperating with the switching assembly to control the electrode assembly,

wherein the first electrical field is for spatially displacing at least a portion of the macromolecules along a first resultant direction and the second electrical field is for moving at least a portion of the macromolecules along a second resultant direction, the first resultant direction substantially opposing the second resultant direction; and

electrophoretically migrating macromolecules introduced at the origin location towards the objective location when applying the first electrical field for a first pulse duration and applying the second electrical field for a second pulse duration in the alternating pulse sequence thereto for separation thereof, the first pulse duration and the second pulse duration being pre-determined, each macromolecule having a plurality of molecular properties and the macromolecules being separated by the migration medium in accordance with at least one of the plurality of molecular properties.

In accordance with a third aspect of the invention, there is disclosed an electrophoresis system for the separation of macromolecules comprising:

an electrophoresis device comprising:
a migration medium having an origin location and an objective location forming extremities thereof; and
an electrode assembly for applying electrical potential through the migration medium,

a controller being in electrical communication with the electrode assembly, the controller cooperating with the electrode assembly for applying in an alternating pulse sequence a first electrical field and a second electrical field to at least a portion of macromolecules introducible at the origin location and containable in the migration medium,

wherein the first electrical field is for spatially displacing at least a portion of the macromolecules along a first resultant direction and the second electrical field is for moving at least a portion of the macromolecules along a second resultant direction, the first resultant direction substantially opposing the second resultant direction,

whereby when macromolecules are introduced at the origin location, applying the first electrical field for a first pulse duration and applying the second electrical field for a second pulse duration in the alternating pulse sequence thereto electrophoretically migrates the maromolecules towards the objective location for separation thereof, the first pulse duration and the second pulse duration being pre-determined, each macromolecule having a plurality of molecular properties and the macromolecules being separated by the migration medium in accordance with at least one of the plurality of molecular properties.

### BRIEF DESCRIPTION OF THE DRAWINGS

Embodiments of the invention are described hereinafter with reference to the following drawings, in which:

FIG. 1 shows a system configuration diagram of an electrophoresis system for implementing a differential alternating field electrophoresis (DAFE) method according to an embodiment of the invention;

FIG. 2 shows a directional-time gait diagram of an alternating pulse sequence generated by the electrophoresis system of FIG. 1;

FIG. 3 shows an electrical schematic of the electrophoresis system of FIG. 1;

FIG. 4 shows a partial pictorial view of the electrophoresis system of FIG. 1 with a switching unit;

FIG. 5 shows a photograph of a gel run in a first example for separation of peptides within a large molecular weight range using a constant field electrophoresis (CFE) method (Segment A) and the DAFE (Segment B) using the electrophoresis system of FIG. 1;

FIG. 6 shows a photograph of a gel run in a second example for separation of protein within a large molecular weight range in a native gel using the CFE method (Segment A) and the DAFE (Segment B) using the electrophoresis system of FIG. 1;

FIG. 7 shows a photograph of a gel run in a third example for separation of peptides within a medium molecular weight range using the CFE method (Segment A) and the DAFE (Segment B) using the electrophoresis system of FIG. 1;

FIG. 8 shows a photograph of a gel run in a fourth example for separation of peptides within a low molecular weight range using the CFE method (Segment A) and the DAFE (Segment B) using the electrophoresis system of FIG. 1; and

FIG. 9 shows a photograph of a gel run in a fifth example for separation of a complex mixture of proteins/peptides using the CFE method (Segment A) and the DAFE (Segment B) using the electrophoresis system of FIG. 1.

### DETAILED DESCRIPTION

An electrophoresis system is described hereinafter for addressing the foregoing problems.

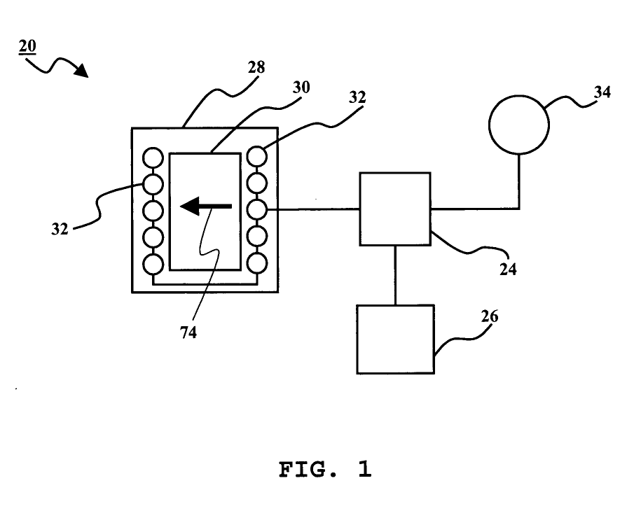

A first embodiment of the invention, an electrophoresis system 20 is described with reference to FIG. 1, which shows a front cross-sectional elevation of the electrophoresis system 20.

The electrophoresis system 20 is for the separating macromolecules and comprises a switching assembly 24 and a controller 26 as shown in FIG. 1. The switching assembly 24 is electrically couplable to an electrophoresis device 28.

The electrophoresis device 28 is a conventional PAGE apparatus with a conventional structural configuration and comprises a migration medium 30, an electrode assembly 32 for applying electrical potential through the migration medium 30 and a power source 34 for one of directly and indirectly providing power to the electrode assembly 32. The power source 34 is electrically couplable to the switching assembly 24, which in turn is electrically couplable to the electrode assembly 32.

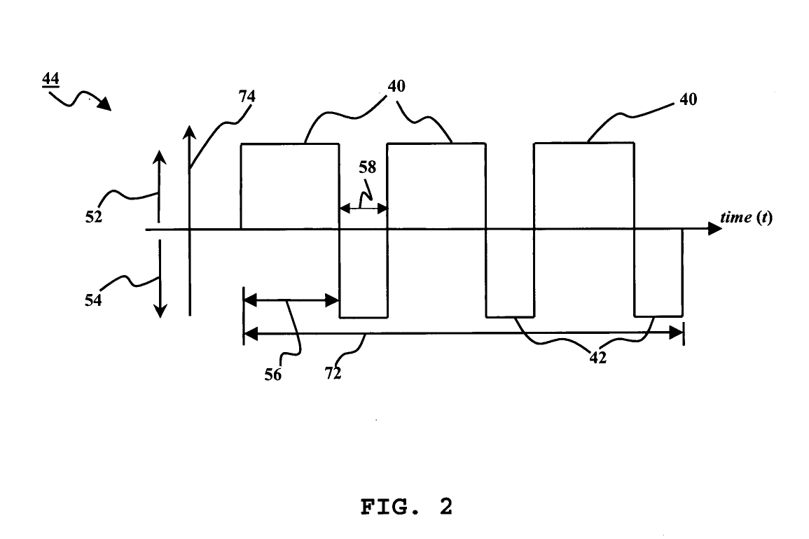

The migration medium 30 has an origin location and an objective location forming extremities thereof. Specifically, macromolecules (not shown) are introduced to the migration medium 30 at the origin location for electrophoretic migration thereof towards the objective location. The controller 26 is in electrical communication with the switching assembly 24. The controller 26 cooperates with the switching assembly 24 to control application of a first electrical field 40 and a second electrical field 42 in an alternating pulse sequence 44, as shown in FIG. 2, by the electrode assembly 32 to a portion of macromolecules received at the origin location and contained in the migration medium 30.

The migration medium 30 is preferably pre-casted sodium doecyl sulphate-polyacrylamide or polyacrylamide mini gel. Alternatively, agarose or other medium having capillaries or nanostructures matrix capable of providing suitable molecular sieving for separating putative macromolecules is also useable as the migration medium 30. Specifically, the migration medium 30 has an effective pore size that is larger than the size of each of the macromolecules to effect observable migration within the migration medium 30.

The switching assembly 24 comprises at least one electrical switch with each of the at least one electrical switches being an electrical relay. Alternatively, each of the at least one electrical switch is a diode array.

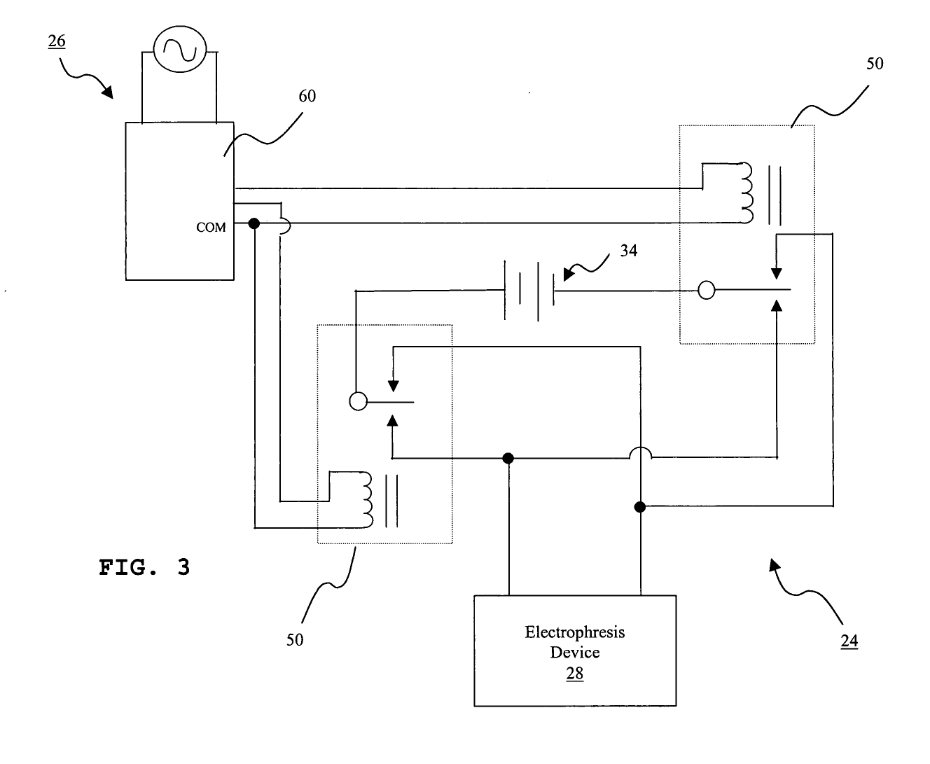

The at least one electrical switch is electrically connected to the electrode assembly 32 and electrically interfaces the electrode assembly 32 and the power source 34. The at least one electrical switch is controllable by the controller 26 for electrically switching and thereby alternating between the first electrical field 40 and the second electrical field 42 for delivery thereof to the migration medium 30. The detailed schematic of the electrophoresis system is shown in FIG. 3 with the at least one electrical switch being a pair of relays 50.

The first electrical field 40 is for moving at least a portion of the macromolecules along a first resultant direction 52 and the second electrical field 42 is for moving at least a portion of the macromolecules along a second resultant direction 54. Preferably, the first resultant direction 52 substantially opposes the second resultant direction 54. Therefore, when macromolecules are introduced at the origin location, applying the first electrical field 40 for a first pulse duration 56 and applying the second electrical field 42 for a second pulse duration 58 in the alternating pulse sequence 44 to the macromolecules results in electrophoretic migration of the macromolecules towards the corresponding objective location for the separation thereof. The first pulse duration 56 and the second pulse duration 58 are pre-determined. Each macromolecule has a plurality of molecular properties with the macromolecules being separated by the migration medium 30 in accordance with at least one of molecular weight, molecular size or the like molecular properties. When the macromolecules are migrated towards the objective location, not all of the macromolecules will reach the objective location. The extent at which each macromolecule will migrate towards the objective location is dependent on the molecular property thereof and preferably on the gel concentration of the migration medium 30.

Preferably, the controller 26 comprises a timer device 60 being in electrical communication with the at least one electrical switch as shown in FIG. 3. The timer device cooperates with the at least one electrical switch for determining the first pulse duration 56 and the second pulse duration 58 for the delivery of the first electrical field 40 and the second electrical field 42 respectively. The timer device is programmable for pre-defining the first pulse duration 56 and the second pulse duration 58. Alternatively, the controller 26 comprises at least one of a programmable logic controller and a programmable integrated circuit being in electrical communication with the at least one electrical switch and being programmable for pre-defining the first pulse duration 56 and the second pulse duration 58.

The first resultant direction 52 is directed substantially away from the origin location and towards the objective location, while the second resultant direction 54 is directed substantially towards the origin location and away from the objective location. Preferably, the first pulse duration 56 is longer than the second pulse duration 58 with the ratio of first pulse duration 56 to second pulse duration 58 being within a range of 2:1.5 to 15:1. Each of the first electrical field 40 and the second electrical field 42 has a pulse intensity, with the pulse intensity of the first electrical field 40 preferably being substantially the same as the pulse intensity of the second electrical field 42.

The migration medium 30 comprises a migration lane extending between the origin location and the objective location. The migration medium 30 is formed for representing a sample molecular weight range and for indicating a plurality of molecular weights within the sample molecular weight range along the migration lane. At least a portion of the macromolecules being subjected to separation is within the sample molecular weight range and therefore separable by the migration medium 30.

The electrophoresis system 20 further comprises an effective molecular weight range constituting at least a portion of the sample molecular weight range. The effective molecular weight range quantitatively extends between an upper molecular weight limit and a lower molecular weight limit, wherewithin separation resolution and molecular weight indication of the macromolecules are substantially superior.

The controller 26 is further programmable for defining a total run duration 72. The first electrical field 40 and the second electrical field 42 are applied to the macromolecules in the alternating pulse sequence 44 within the total run duration 72. Preferably, the upper molecular weight limit and the lower molecular weight limit are further determinable by the gel concentration of the migration medium 30.

The upper molecular weight limit and the lower molecular weight limit are functions of and therefore are substantially determined by the first pulse duration 56, the second pulse duration 58 and the total run duration 72.

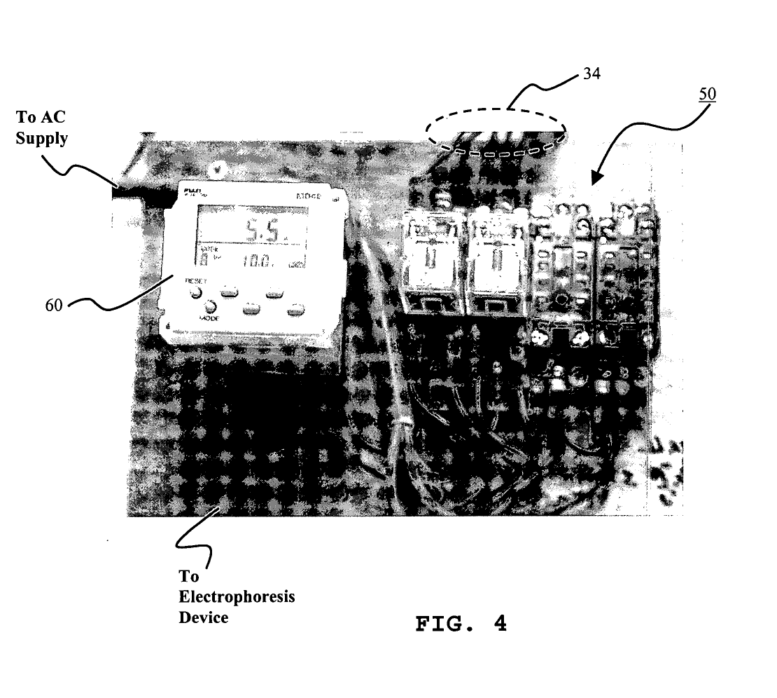

The electrophoresis system 20 is easily incorporated to the conventional electrophoresis device 28 for integration therewith without any major electrical or structural modifications thereto as shown in FIG. 1, FIG. 3 and pictorially illustrated in FIG. 4.

The electrophoresis system 20 is for implementing a Differential Alternating Field Electrophoresis (DAFE) method. In the DAFE method, the electrophoresis system 20 is coupled to the migration medium 30 and applies the first electrical field 40 to the macromolecules introduced to the origin location thereof.

The macromolecules are at least one a type of polypeptide molecules.

The first electrical field 40 causes the reputation of the macromolecules via electrophoresis migration in the first resultant direction 52. However, due to the structure of the macromolecules, a portion of the macromolecules will be lodged or trapped in the pores of the migration medium 30 to thereby inhibit further migration in the first resultant direction 52.

The first electrical field 40 is applied to the macromolecules for only the first pulse duration 56, after which, the second electrical field 42 is applied to the macromolecules in the absence of the first electrical field 40.

The second electrical field 42 causes the reputation of the macromolecules in the second resultant direction 54 for dislodging or detrapping at least a portion thereof from the pores of the migration medium 30. The second electrical field 42 is applied only for the second pulse duration 58, following which, the first electrical field 40 is reapplied to the macromolecules in the absence of the first electrical field 40.

The first electrical field 40 and the second electrical field 42 are applied to the macromolecules in the alternating pulse sequence 44 with a resultant migration direction 74 being determined by the ratio between the first pulse duration 56 and the second pulse duration 58. Therefore, the controller 26 is programmed for pre-defining the first pulse duration 56 and the second pulse duration 58, for the resultant migration direction 74 to be substantially in the direction of the first resultant direction, and to facilitate migration of the macromolecules towards the objective location.

The DAFE method of applying the first electrical field 40 and the second electrical field 42 in the alternating pulse sequence 44 creates an advancing-dislodging effect on the macromolecules. The advancing-dislodging effect of the DAFE method facilitates migration of the macromolecules through the migration medium 30 and thereby results in improved resolution and separation of the macromolecules using only the conventional electrophoresis device 28.

The following examples demonstrate certain aspects of the invention, the electrophoresis system 20 and the DAFE method when applied to the separation of the macromolecules, and should not be taken as limiting the scope thereof.

Protein samples consisting human apolipo-protein, rabbit myosin light and heavy chains, human serum, foetal calf serum, thyroglobulin and bovine albumin were obtained for forming the macromolecules. The electrophoresis device 28 has other accessories comprising gel running apparatus, buffer chambers, cells, gel-casting apparatus and pre-stained protein molecular weight markers which are conventionally available from, for example, Biorad, Novex, Invitrogen or the like electrophoresis equipment suppliers. Each of the at least one electrical switch being an AC relay and the power source 34 being an AC power source. A time delay digital timer device is used as the timer device.

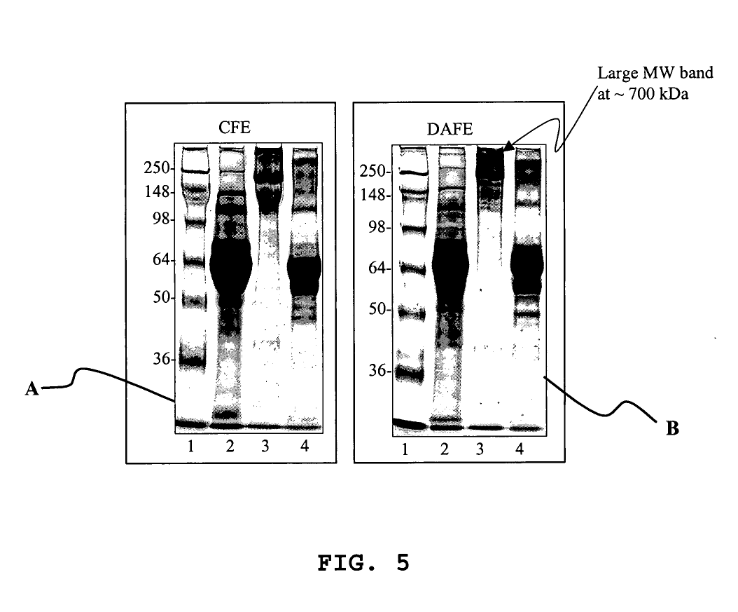

In a first example, peptides and proteins from three different molecular weight (MW) groups, mainly a) a complex protein mixtures, i.e. foetal calf serum (FCS); b) large and medium molecular weight protein, thyroglobulin (non-denatured MW is 669 kDa and denatured MW=238 kD and c) low molecular weight protein, bovine albumin with MW at 67 kDa were separated using a constant field electrophoresis (CFE) method and the DAFE method which uses the electrophoresis system 20. The separation results for the CFE method and the DAFE method are respectively shown in segments A and B of FIG. 5. Lane 1 is molecular weight standards while lanes 2, 3 and 4 are 15 μg of FCS, 10 μg of thyroglobulin and 10 μg of albumin respectively. For the DAFE method, the first pulse duration 56 is 300 milliseconds (ms) and the second pulse duration 58 is 160 ms and the total run duration 72 is 157 minutes (mins). 5% separation gel was used for the migration medium 30 with each of the first electrical field 40 and the second electrical field 42 being at 200 volt.

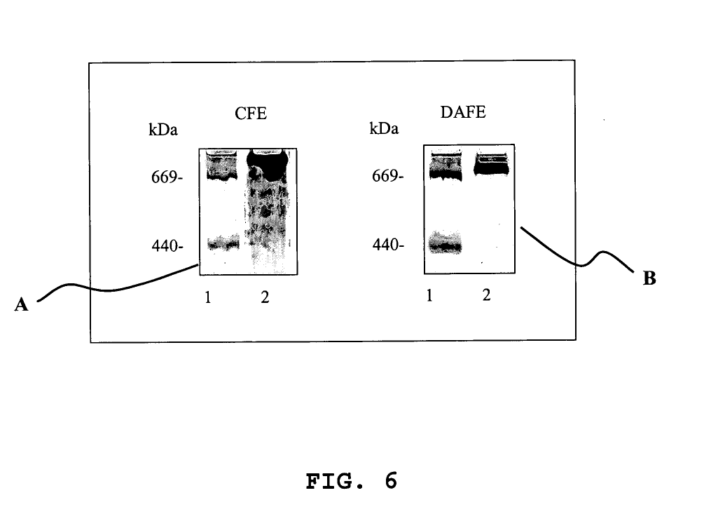

As shown in of FIG. 5, there were relatively more molecular species with MW which are greater than 100 kDa being resolved when the different protein groups were analysed by DAFE as compared to CFE. Within each protein group, there is an indeterminate number of different protein/peptides species depending on their degree of complexity and purity. Hence, DAFE is a more superior method when compared to CFE and taking into account the resolution of the number of discernable protein/peptides bands. There was a large molecular weight band at approximately 700 kDa observed in segment B of FIG. 5, which suggests that DAFE has the ability to resolve large molecular weight protein species. Such ability is associated with the advancing and detrapping nature of DAFE has upon the macromolecules subjected for separation, see FIG. 6.

In a second example as shown in FIG. 6, DAFE demonstrated superiority over CFE for the separation of large molecular weight protein. Lane 1, and 2 are molecular weight standards and 30 μg of modified non-denatured GroEL with native molecular weight of approximately 890 kDa. For the DAFE method, the first pulse duration 56 is 80 ms and the second pulse duration 58 is 40 ms and the total run duration 72 is 180 mins. 8% separation gel is used for the migration medium 30 with each of the first electrical field 40 and the second electrical field 42 being at 200 volt. This example also implicates that DAFE is most likely to be applicable for resolving high molecular weight DNA and DNA-protein molecules and complexes.

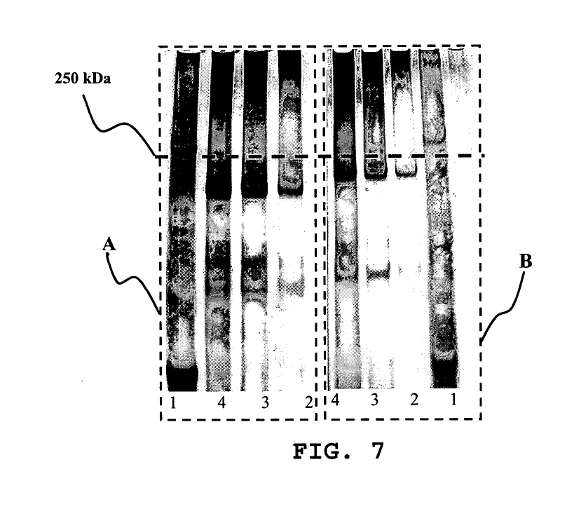

In a third example, peptides and proteins again for the medium molecular weight range were separated using the CFE method and the DAFE method which uses the electrophoresis system 20. In the third example, the macromolecules again comprise rabbit heavy chain myosin. For the DAFE method, the first pulse duration 56 is 300 ms and the second pulse duration 58 is 20 ms and the total run duration 72 is 150 mins. 5% separation gel is used for the migration medium 30 with each of the first electrical field 40 and the second electrical field 42 being at 100 volt. The separation results for the conventional CFE method and the DAFE method are respectively shown in segments A and B of FIG. 7. Lane 1 is a molecular weight marker while lanes 2, 3 and 4 are 450 ng, 900 ng and 1800 ng of myosin for each of segments A and B of FIG. 7.

As observable from segment B of FIG. 7 for the DAFE method, mobilities of the macromolecules relative to the same macromolecules used in the CFE method of segment A of FIG. 7 decreased and suggests that DAFE under the right conditions has the ability to compress certain molecular species to the top of the gel (as in this case), and thereby has the capability to selectively enhanced certain molecular weight zone on the physical gel for molecular weight analysis.

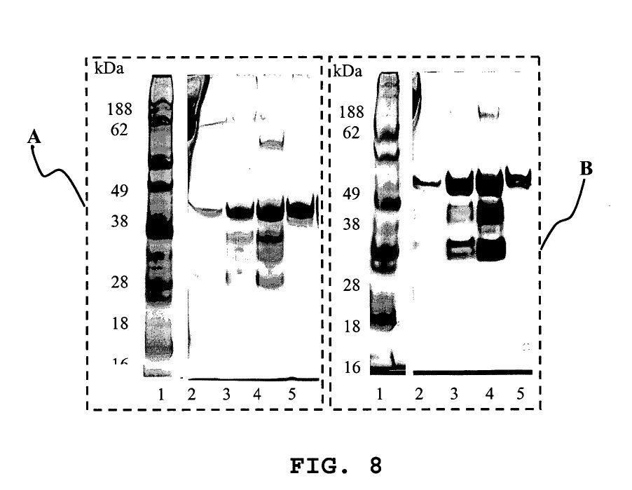

In a fourth example, peptides and proteins again for the low molecular weight range were separated using the CFE method and the DAFE method which uses the electrophoresis system 20. In the fourth example, the macromolecules comprise rabbit light chain myosin and human apolipoprotein. For the DAFE method, the first pulse duration 56 is 80 ms and the second pulse duration 58 is 40 ms and the total run duration 72 is 12 hours (hrs). 20% separation gel is used for the migration medium 30 with each of the first electrical field 40 and the second electrical field 42 being at 100 volt. The separation results for the CFE method and the DAFE method are respectively shown in segments A and B of FIG. 8. Lane 1 is a molecular weight marker while lanes 2, 3 and 4 are 450 ng, 900 ng and 1800 ng of myosin and lane 5 is 200 ng of human apolipoprotein AI for each of segments A and B of FIG. 8.

As observable from segment B of FIG. 8 for the DAFE method, separation, resolution and sharpness of band for the myosin light chain within the effective molecular weight range of between 16 kDa to 34 kDa are substantially superior to that for the CFE method of FIG. 8a. Furthermore, human apolipoprotein AI is unresolved for the CFE method while a second isoform is prominently observable for the DAFE method of segment B of FIG. 8. The fourth example demonstrates that low molecular weight protein isoforms are resolvable using the DAFE method applied by the electrophoresis system 20.

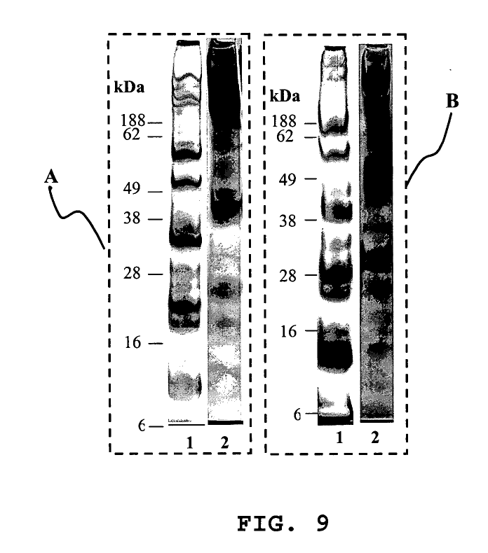

In a fifth example, a complex mixture of peptides and proteins were separated using the CPE method and the DAFE method which uses the electrophoresis system 20. In the fifth example, the macromolecules comprise human serum. For the DAFE method, the first pulse duration 56 is 80 ms and the second pulse duration 58 is 40 ms and the total run duration 72 is 12 hours (hrs). 20% separation gel is used for the migration medium 30 with each of the first electrical field 40 and the second electrical field 42 being at 100 volt. The run time for the CFE method is 270 mins. The separation results for the CFE method and the DAFE method are respectively shown in segments A and B of FIG. 9. Lane 1 is a molecular weight marker while lane 2 is 8 μg of human serum for each of segments A and B of FIG. 9.

As observable from segment B of FIG. 9, higher molecular weight species demonstrate a reduction in mobility for the DAFE method, thereby providing a larger separating distance for smaller molecular weight species as compared to the CFE method of segment A of FIG. 9. The larger separating distance provided by the DAFE method further contributes to separating resolution for smaller molecular weight species with a larger separating gel (the migration medium 30).

In the foregoing manner, an electrophoresis system for implementing a differential alternating fields electrophoresis (DAFE) method is described according to one embodiment of the invention for addressing the foregoing disadvantages of conventional constant field electrophoresis (CFE) methods. Five examples for contrasting the DAFE method with a CFE method are provided. Although only one embodiment of the invention are disclosed, it will be apparent to one skilled in the art in view of this disclosure that numerous changes and/or modification can be made without departing from the scope and spirit of the invention.

1. An electrophoresis system for separating macromolecules comprising:
a switching assembly;
an electrophoresis device being electrically couplable to the switching assembly, the electrophoresis device comprising:
a migration medium having an origin location and an objective location forming extremities thereof, and
an electrode assembly for applying electrical potential through the migration medium, the switching assembly being in electrical communication with the electrode assembly; and
a controller being in electrical communication with the switching assembly, the controller cooperating with the switching assembly to control application of a first electrical field and a second electrical field in an alternating pulse sequence by the electrode assembly to at least a portion of macromolecules introducible at the origin location and containable in the migration medium,
wherein the first electrical field is for spatially displacing at least a portion of the macromolecules along a first resultant direction and the second electrical field is for moving at least a portion of the macromolecules along a second resultant direction, the first resultant direction substantially opposing the second resultant direction,
whereby when macromolecules are introduced at the origin location, applying the first electrical field for a first pulse duration and applying the second electrical field for a second pulse duration in the alternating pulse sequence thereto electrophoretically migrates the maromolecules towards the objective location for separation thereof, the first pulse duration and the second pulse duration being pre-determined, each macromolecule having a plurality of molecular properties and the macromolecules being separated by the migration medium in accordance with at least one of the plurality of molecular properties.

2. The electrophoresis system as in claim 1, the plurality of molecular properties comprising molecular weight, molecular size and molecular conformation.

3. The electrophoresis system as in claim 1, the migration medium being one of a solid-phase matrix and a solid-phase system formed for separating macromolecules.

4. The electrophoresis system as in claim 3, the migration medium being one of polyacrylamide gel and agarose.

5. The electrophoresis system as in claim 1, the migration medium being one of sodium doecyl sulphate-polyacrylamide gel and polyacrylamide gel.

6. The electrophoresis system as in claim 1, the migration medium having an effective pore size being larger than the size of each of the macromolecules.

7. The electrophoresis system as in claim 1, the first resultant direction being directed substantially away from the origin location and the second resultant direction being directed substantially towards the origin location.

8. The electrophoresis system as in claim 1, the first pulse duration being longer than the second pulse duration.

9. The electrophoresis system as in claim 1, the ratio of first pulse duration to second pulse duration is within a range of 2:1.5 to 15:1.

10. The electrophoresis system as in claim 1, the macromolecules being at least one of polypeptide molecules, myosin molecules, hyaluronic acid molecules, giant protein complex and complex protein mixture.

11. The electrophoresis system as in claim 1, the pulse intensity of the first electrical field being substantially the same as the pulse intensity of the second electrical field.

12. The electrophoresis system as in claim 1, the switching assembly comprising:
at least one electrical switch being electrically connected to the electrode assembly and electrically interfacing the electrode assembly and a power source, the at least one electrical switch being controllable by the controller for electrically switching and thereby alternating between the first electrical field and the second electrical field for delivery to the migration medium.

13. The electrophoresis system as in claim 12, each of the at least one electrical switch being at least one of a relay assembly and a diode array.

14. The electrophoresis system as in claim 12, the controller comprising:
a timer device being in electrical communication with the at least one electrical switch, the timer device cooperating with the at least one electrical switch for determining the first pulse duration and the second pulse duration, and the timer device being programmable for pre-defining the first pulse duration and the second pulse duration.

15. The electrophoresis system as in claim 12, the controller comprising:
at least one of a programmable logic controller and a programmable integrated circuit being in electrical communication with the at least one electrical switch and being programmable for pre-defining the first pulse duration and the second pulse duration, the at least one of a programmable logic controller and a programmable integrated circuit cooperating with the at least one electrical switch for determining the first pulse duration and the second pulse duration, and the timer device.

16. The electrophoresis system as in claim 1, the migration medium comprising a migration lane extending between the origin location and the objective location, the migration medium being formed for representing a sample molecular weight range and for indicating a plurality of molecular weights within the sample molecular weight range along the migration lane, at least a portion of the macromolecules being within the sample molecular weight range and therefore separable by the migration medium.

17. The electrophoresis system as in claim 16, further comprising:
a effective molecular weight range constituting at least a portion of the sample molecular weight range, the effective molecular weight range quantitatively extending between an upper molecular weight limit and a lower molecular weight limit, wherewithin separation resolution and molecular weight indication of the macromolecules are substantially improved.

18. The electrophoresis system as in claim 17, the controller further being programmable for defining a total run duration, the first electrical field and the second electrical field are applied to the macromolecules in the alternating pulse sequence within the total run duration.

19. The electrophoresis system as in claim 18, the upper molecular weight limit and the lower molecular weight limit being functions of and therefore being substantially determined by the first pulse duration, the second pulse duration and the total run duration.

20. A differential alternating field electrophoresis (DAFE) method for separating macromolecules comprising the steps of:
providing an electrophoresis device comprising:
a migration medium having an origin location and an objective location forming extremities thereof; and
an electrode assembly for applying electrical potential through the migration medium,
providing a switching assembly being electrically couplable to the electrophoresis device, the switching assembly being in electrical communication with the electrode assembly;
electrically communicating a controller with the switching assembly;
applying a first electrical field and a second electrical field in an alternating pulse sequence by the electrode assembly to at least a portion of macromolecules introducible at the origin location and containable in the migration medium, the controller cooperating with the switching assembly to control the electrode assembly,
wherein the first electrical field is for spatially displacing at least a portion of the macromolecules along a first resultant direction and the second electrical field is for moving at least a portion of the macromolecules along a second resultant direction, the first resultant direction substantially opposing the second resultant direction; and
electrophoretically migrating macromolecules introduced at the origin location towards the objective location when applying the first electrical field for a first pulse duration and applying the second electrical field for a second pulse duration in the alternating pulse sequence thereto for separation thereof, the first pulse duration and the second pulse duration being pre-determined, each macromolecule having a plurality of molecular properties and the macromolecules being separated by the migration medium in accordance with at least one of the plurality of molecular properties.

21. The DAFE method as in claim 20, the step of providing an electrophoresis device comprising the step of:
providing the migration medium for separating the macromolecules in accordance with the plurality of molecular properties comprising molecular weight, molecular size and molecular conformation.

22. The DAFE method as in claim 20, the step of providing an electrophoresis device comprising the step of:
providing an electrophoresis device with the migration medium being one of a solid-phase matrix and a solid-phase system formed for separating macromolecules.

23. The DAFE method as in claim 20, the step of providing an electrophoresis device comprising the step of:
providing an electrophoresis device with the migration medium being one of polyacrylamide gel and agarose.

24. The DAFE method as in claim 20, the step of providing an electrophoresis device comprising the step of:
providing an electrphoresis device with the migration medium being one of sodium doecyl sulphate-polyacrylamide gel and polyacrylamide gel.

25. The DAFE method as in claim 20, the step of providing an electrophoresis device comprising the step of:
providing an electrphoresis device with the migration medium having an effective pore size being larger than the size of each of the macromolecules.

26. The DAFE method as in claim 20, the step of applying a first electrical field and a second electrical field in an alternating pulse sequence comprising the step of:
applying the first electrical field with the first resultant direction being directed substantially away from the origin location; and
applying the second electrical field with the second resultant direction being directed substantially towards the origin location.

27. The DAFE method as in claim 20, the step of applying a first electrical field and a second electrical field in an alternating pulse sequence comprising the step of:
applying the first electrical field and the second electrical field with the first pulse duration being longer than the second pulse duration.

28. The DAFE method as in claim 20, the step of applying a first electrical field and a second electrical field in an alternating pulse sequence comprising the step of:
applying the first electrical field and the second electrical field with the ratio of first pulse duration to second pulse duration is within a range of 2:1.5 to 15:1.

29. The DAFE method as in claim 20, the step of electrophoretically migrating the macromolecules comprising the step of:
electrophoretically migrating molecules being at least one of polypeptide molecules, myosin molecules, hyaluronic acid molecules, giant protein complex and complex protein mixture.

30. The DAFE method as in claim 20, the step of applying a first electrical field and a second electrical field in an alternating pulse sequence comprising the step of:
applying the first electrical field and the second electrical field with the pulse intensity of the first electrical field being substantially the same as the pulse intensity of the second electrical field.

31. The DAFE method as in claim 20, the step of providing a switching assembly comprising the step of:
providing at least one electrical switch being electrically connected to the electrode assembly and electrically interfacing the electrode assembly and a power source, the at least one electrical switch being controllable by the controller for electrically switching and thereby alternating between the first electrical field and the second electrical field for delivery to the migration medium.

32. The DAFE method as in claim 31, the step of providing at least one electrical switch comprising the step of:
providing at least one electrical switch with each of the at least one electrical switch being at least one of a relay assembly and a diode array.

33. The DAFE method as in claim 31, the step of electrically communicating a controller with the switching assembly comprising the step of:
electrically communicating a timer device with the at least one electrical switch, the timer device cooperating with the at least one electrical switch for determining the first pulse duration and the second pulse duration, and the timer device being programmable for pre-defining the first pulse duration and the second pulse duration.

34. The DAFE method as in claim 31, the step of electrically communicating a controller with the switching assembly comprising the step of:
electrically communicating at least one of a programmable logic controller and a programmable integrated circuit with the at least one electrical switch and being programmable for pre-defining the first pulse duration and the second pulse duration, the at least one of a programmable logic controller and a programmable integrated circuit cooperating with the at least one electrical switch for determining the first pulse duration and the second pulse duration, and the timer device.

35. The DAFE method as in claim 20, the step of providing an electrophoresis device comprising the step of:
providing the migration medium with a migration lane extending between the origin location and the objective location, the migration medium being formed for representing a sample molecular weight range and for indicating a plurality of molecular weights within the sample molecular weight range along the migration lane, at least a portion of the macromolecules being within the sample molecular weight range and therefore separable by the migration medium.

36. The DAFE method as in claim 35, the step of providing an electrophoresis device further comprising the step of:
providing a effective molecular weight range constituting at least a portion of the sample molecular weight range, the effective molecular weight range quantitatively extending between an upper molecular weight limit and a lower molecular weight limit, wherewithin separation resolution and molecular weight indication of the macromolecules are substantially improved.

37. The DAFE method as in claim 36, the step of electrically communicating a controller with the switching assembly comprising the step of:
programming the controller for defining a total run duration, the first electrical field and the second electrical field are applied to the macromolecules in the alternating pulse sequence within the total run duration.

38. The DAFE method as in claim 37, the step of providing a effective molecular weight range comprising the step of:
providing the effective molecular weight range with the upper molecular weight limit and the lower molecular weight limit being functions of and therefore being substantially determined by the first pulse duration, the second pulse duration and the total run duration.

39. An electrophoresis system for the separation of macromolecules comprising:
an electrophoresis device comprising:
a migration medium having an origin location and an objective location forming extremities thereof; and
an electrode assembly for applying electrical potential through the migration medium,
a controller being in electrical communication with the electrode assembly, the controller cooperating with the electrode assembly for applying in an alternating pulse sequence a first electrical field and a second electrical field to at least a portion of macromolecules introducible at the origin location and containable in the migration medium,
wherein the first electrical field is for spatially displacing at least a portion of the macromolecules along a first resultant direction and the second electrical field is for moving at least a portion of the macromolecules along a second resultant direction, the first resultant direction substantially opposing the second resultant direction,
whereby when macromolecules are introduced at the origin location, applying the first electrical field for a first pulse duration and applying the second electrical field for a second pulse duration in the alternating pulse sequence thereto electrophoretically migrates the maromolecules towards the objective location for separation thereof, the first pulse duration and the second pulse duration being pre-determined, each macromolecule having a plurality of molecular properties and the macromolecules being separated by the migration medium in accordance with at least one of the plurality of molecular properties.
